(19) United States
(12) Patent Application Publication
(10) Pub. No.: US 2011/0053576 A1
(43) Pub. Date: Mar. 3, 2011

(54) Automatic Profiler

(76) Inventor: Javia Jermaine Shaw, Saint Petersburg, FL (US)

(21) Appl. No.: 12/550,347

(22) Filed: Aug. 28, 2009

(51) Int. Cl. H04M 3/00

(52) U.S. Cl. 455/418

(57) ABSTRACT

An application called the Automatic Profiler used in a cell phone environment that enables the profile of the cell phone to automatically adjust according to preprogrammed settings. The program will allow the user to initially set-up/program specific times when the individuals' cell phone will transition from one profile to another. A profile being defined as the setting that the unit responds to alerts/stimulus etc. (not only limited to calls).

### CROSS-REFERENCE TO RELATED APPLICATIONS, STATEMENT REGARDING FEDERALLY SPONSORED RESEARCH OR DEVELOPMENT, REFERENCE TO SEQUENCE LISTING, A TABLE OR A COMPUTER PROGRAM LISTING COMPACT DISC APPENDIX

Not Applicable

### BACKGROUND OF THE INVENTION

The Automatic Profiler into the field of Software Development and its use is specified here to that of cell phones but it was envisioned to be expandable to any product that could benefit from its uses. The problem arose from noticing that multiple people's cell phones would ring at inappropriate times during normal work hours.

### BRIEF SUMMARY OF THE INVENTION

The Automatic Profiler solves the problem of having one's cell phone ring at inappropriate times during scheduled activities. (For example during normal work hours) In the example the profiler would recognize the time scheduled for work and transition the unit from say an loud ring setting to a vibrate or silent profile. Family activities or even schedule downtime could be possible uses. If the event or activity is planned then the automatic profiler can be used to avert an inappropriate phone stimulus.

### BRIEF DESCRIPTION OF THE SEVERAL VIEWS OF THE DRAWING

Not Applicable

### DETAILED DESCRIPTION OF THE INVENTION

The Automatic Profiler a software application when used in a cell phone environment will enable the profile of the cell phone to automatically adjust according to the preprogrammed settings.

The Automatic Profiler will:
1. Allow a cell phone to transition from one profile to another from preprogrammed settings without additional user input.
2. Be capable of operating without interrupting normal cell phone operation.
3. Allow the user to manually change the cell phone's profile to one different from that initiated by the Automatic Profiler.
4. While the Automatic Profiler is still engaged, if a manual profile set by the user, the application will maintain the users' initiated setting until the next scheduled profile at which time the Automatic Profiler will transition to its scheduled profile.
5. The cell phone user can at anytime, change/reprogram or turnoff the Automatic Profiler
6. Once turned on the Automatic Profiler will be engaged until the user turns the application off. (persistent through a system shutdown)

1. The Automatic Profiler an application when used in a cell phone environment will enable the profile of the cell phone to automatically adjust according to the preprogrammed settings.
